(19) United States
(12) Patent Application Publication
(10) Pub. No.: US 2026/0189306 A1
(43) Pub. Date: Jul. 2, 2026

(54) OPTICAL INTENSITY MODULATION APPARATUS AND LASER SYSTEMS

(71) Applicant: NKT PHOTONICS A/S, Birkerød (DK)

(72) Inventor: Martin Romme HENRIKSEN, Birkerød (DK)

(73) Assignee: NKT PHOTONICS A/S, Birkerød (DK)

(21) Appl. No.: 19/130,499

(22) PCT Filed: Dec. 19, 2023
(86) PCT No.: PCT/EP2023/086617

§ 371 Date: May 15, 2025

(30) Foreign Application Priority Data
Dec. 23, 2022 (EP) 22216397.4

(51) Int. Cl. H04B 10/54

(52) U.S. Cl. CPC H04B 10/54

(57) ABSTRACT

Optical intensity modulation apparatus including: an optical modulator operative to modulate a continuous-wave optical carrier signal at a carrier wavelength to generate at least one sideband on the optical carrier signal; a radio frequency, RF, signal generator operative to provide an RF drive signal to the optical modulator; a first optical waveguide grating having a central reflection wavelength corresponding to a sideband; and optical circulator configured to direct the optical carrier signal and the at least one sideband to the first optical waveguide grating and to direct a reflected optical signal from the first optical waveguide grating towards an output to form an output optical signal. The RF signal generator is operative to switch the drive signal on and off so as to form an intensity modulated output optical signal.

### TECHNICAL FIELD

The invention relates to an optical intensity modulation apparatus. The invention further relates to a laser system including the optical intensity modulation apparatus. The invention further relates to a system for coherent excitation. The invention further relates to a quantum computing system. The invention further relates to a system for coherent state control of a quantum system.

### BACKGROUND

Fast optical intensity modulation of optical signals is typically performed using an acousto-optic modulator, AOM, a Mach-Zehnder electro-optic modulator, MZM-EOM, or a semi-conductor optical amplifier, SOA. AOMs have a high extinction ratio and the intensity modulation can be controlled to produce no phase shift to the optical signal (which may be referred to as “phase/amplitude coupling”) but have a slow rise time meaning they are not suitable for ultra-fast intensity modulation. MZM-EOMs have a fast rise time, but have a low extinction ratio, meaning they are not suitable for applications requiring amplification of pulse trains having a long dark time, and produce phase/amplitude coupling, meaning they are not suitable for applications requiring precise phase control of the optical signal. SOAs have a high extinction ratio, a rise time significantly faster than AOMs but slower than a MZM-EOM, and produce phase/amplitude coupling.

### SUMMARY

It is an object to provide an improved optical intensity modulation apparatus. It is a further object to provide an improved laser system. It is a further object to provide an improved system for coherent excitation. It is a further object to provide an improved optical system for quantum computing. It is a further object to provide an improved apparatus for coherent state control of a quantum system.

An aspect provides optical intensity modulation apparatus comprising an optical modulator, a radio frequency, RF, signal generator, a first optical waveguide grating and optical routing apparatus. The optical modulator is operative to modulate a continuous-wave, cw, optical carrier signal at a carrier wavelength to generate at least one sideband on the optical carrier signal. The at least one sideband may be a first order sideband, such as an upper or lower sideband, from the carrier wavelength. The modulated signal output from the modulator may comprise a plurality of sidebands of higher order. The RF signal generator is operative to provide an RF drive signal to the optical modulator. The first optical waveguide grating preferably has a central reflection wavelength corresponding to a said sideband. The waveguide grating may further have a reflection bandwidth selected such that is does not overlap the carrier signal, i.e. such that the bandwidth is equal to or less than the frequency offset of the sideband to the carrier signal. The reflection bandwidth may be defined at full width at half maximum (FWHM). The optical routing apparatus is configured to direct the optical carrier signal and the at least one sideband to the first optical waveguide grating and to direct a reflected optical signal from the first optical waveguide grating towards an output to form an output optical signal. The RF signal generator is operative to switch the drive signal on and off so as to form an intensity modulated output optical signal.

The optical intensity modulation apparatus may provide a high extinction ratio (ER), fast rise time (RT) and/or fall time (FT), and independent phase and amplitude control of an optical pulse. Preferably, the optical intensity modulation apparatus is configured such that there is no coupling between the imposed phase and amplitude. Many quantum systems, such as quantum computers, atomic clocks and atom interferometers, require unique amplitude shaped pulses and full control of the optical phase. Furthermore, a high extinction ratio is required for energy efficient amplification of pulse trains with long dark time. The extinction ratio may be understood to have its common meaning in the technical field. One definition is that the extinction ratio is the ratio of the optical power level generated when the modulator is open, and the power level generated when the modulator is closed. It may be expressed as a fraction, in dB, or as a percentage. The optical intensity modulation apparatus may provide an improvement on the aforementioned parameters compared to the AOM, MZ-EOM and SOA described above. As an example, the optical intensity modulation apparatus may have an extinction ratio higher than 30 dB, such as higher than 40 dB, such as at least 50 dB. The rise time of the apparatus may be extremely fast, such that the rise time is less than 1 ns, or less than 500 ps, or even less than 100 ps. The rise time may be understood as the time between 10% signal to 90% signal, e.g. in terms of power or detected voltage.

In an embodiment, the first optical waveguide grating is a first fibre Bragg grating.

In an embodiment, the first fibre Bragg grating is an apodized fibre Bragg grating having a raised Gaussian reflection profile and constant grating period. This may enable very good sidelobe suppression and a sharp reflection profile, and hence the first FBG is suited for separating signals that are closely spaced in frequency.

In an embodiment, the optical routing apparatus is an optical circulator.

In an embodiment, the optical modulation apparatus further comprises an output optical waveguide grating provided after the optical routing apparatus, i.e. between the optical routing apparatus and the output of the optical intensity modulation apparatus. The output optical waveguide grating may have a reflection bandwidth including the carrier wavelength. The output optical waveguide grating may further improve the extinction ratio of the optical modulation apparatus, by further supressing the optical carrier signal.

Preferably, there is substantially no reflection of the optical carrier signal, or of any other generated sidebands than said sideband, back to the optical routing apparatus from the first optical waveguide grating. The sideband of interest may be a first order sideband next to the carrier signal, e.g. an upper or lower sideband on either side of the carrier signal.

In an embodiment, the optical modulator and the optical routing apparatus are arranged along a first optical path, and the optical routing apparatus and the first optical waveguide grating are arranged along a second optical path, where the second optical path does not contain an optical waveguide grating having a central reflection wavelength corresponding to the carrier signal or other generated sidebands than said sideband. The optical carrier signal and other generated sidebands are then transmitted by the first optical waveguide grating, e.g. to an optical dump at the end of the second optical path. Thereby, the output optical signal is only output when the optical modulator generates said sideband. The optical dump may constitute or comprise an optical isolator. Alternatively, other fiber cable terminations may be used, such as a fiber pigtail, or an anti-reflection coated fiber end-cap.

In an embodiment, the first optical path does not contain other optical waveguide gratings than the first optical waveguide grating.

In an embodiment, the first optical waveguide grating may be arranged in a first optical waveguide which is free of an optical waveguide grating having a central reflection wavelength corresponding to the carrier signal or other generated sidebands than said sideband, such as other optical waveguide gratings than the first optical waveguide grating.

Preferably, any reflection of the optical carrier signal in the first optical waveguide towards the output is less than 10%, such as less than 5%, such as less than 2%, such as less than 1% of the optical carrier signal directed to the first optical waveguide grating.

In an embodiment, the output optical waveguide grating is a further Bragg grating.

In an embodiment, the optical modulation apparatus further comprises a second optical waveguide grating and second optical routing apparatus. The second optical waveguide grating has a central reflection wavelength corresponding to the said sideband. The second optical routing apparatus is configured to direct the reflected optical signal from the first optical waveguide grating to the second optical waveguide grating and to direct a second reflected optical signal from the second optical waveguide grating towards the output. The second optical waveguide grating may further improve the extinction ratio of the optical modulation apparatus.

In an embodiment, the second optical waveguide grating is a second fibre Bragg grating.

In an embodiment, the second fibre Bragg grating is an apodized fibre Bragg grating having a raised Gaussian reflection profile and constant grating period. This may enable very good sidelobe suppression and a sharp reflection profile, and hence the second FBG is suited for separating signals that are closely spaced in frequency.

In an embodiment, the second optical routing apparatus is a second optical circulator.

In an embodiment, the optical modulation apparatus further comprises an output optical waveguide grating provided after the second optical routing apparatus. The output optical waveguide grating may have a reflection bandwidth including the carrier wavelength. The output optical waveguide grating may further improve the extinction ratio of the optical modulation apparatus, by further supressing the optical carrier signal.

In an embodiment, the output optical waveguide grating is a further fibre Bragg grating.

In an embodiment, the optical modulator is operative to modulate the cw optical carrier signal to generate a lower sideband and an upper sideband on the optical carrier signal. The first optical waveguide grating has a central reflection wavelength corresponding to one of the lower sideband and the upper sideband. The optical modulator may be operative to modulate the cw optical carrier signal to generate only the lower and upper sidebands and not any further sidebands on the optical carrier signal. This is advantageous over apparatuses which generates further sidebands, since the optical power of the modulated carrier signal then is maintained in only two side bands rather than being distributed to several sidebands.

In an embodiment, the output optical waveguide grating has a reflection bandwidth including the carrier wavelength and the other of the upper sideband or the lower sideband. The output optical waveguide grating may further improve the extinction ratio of the optical modulation apparatus, by further supressing the optical carrier signal and the other of the upper sideband or the lower sideband.

In an alternative embodiment, the optical modulator is a single sideband, SSB, modulator operative to modulate the cw optical carrier signal to generate a single sideband on the optical carrier signal. The optical modulator may be operative to modulate the cw optical carrier signal to generate only the single sideband and not any further sidebands on the optical carrier signal. This is advantageous over apparatuses which generates two or more further sidebands, since the optical power of the modulated carrier signal then is maintained in only the single sideband rather than being distributed to several sidebands. In some embodiments, the optical modulator comprises a serrodyne modulator. The first optical waveguide grating has a central reflection wavelength corresponding to the generated sideband.

In an embodiment, the RF signal has a frequency of up to 100 GHz, such as a frequency in the range 1 GHz to 20 GHz. The first optical waveguide grating may have a reflection bandwidth equal to or less than the frequency of the RF drive signal.

Corresponding embodiments and advantages apply to the laser system, quantum computing system and system for coherent excitation described below.

In an embodiment, the RF signal generator is operative to provide an RF drive signal comprising RF signal pulses having a compensating pulse shape such that the at least one sideband comprises optical pulses having the compensating pulse shape. The compensating pulse shape is configured to compensate for an optical amplifier non-uniform gain response in the time domain. The optical modulation apparatus may thus be used to deliver a pre-shaped optical pulse to an optical amplifier, enabling a pulse of a desired pulse shape to be output from the optical amplifier. FIGS. 17-18 show an example of a pre-shaped optical pulse and an optical pulse output from the optical amplifier, respectively. The shape of the optical pulse may be controlled by controlling or modulating the amplitude of the RF drive signal. Thus, the amplitude modulation of the optical signal may correspond to the amplitude modulation of the RF drive signal.

An aspect provides a laser system comprising an optical source and optical intensity modulation apparatus. The optical source is preferably configured for generating a continuous-wave, cw, optical carrier signal at a carrier wavelength. The optical source may be a laser, such as a single-frequency fiber laser. In some embodiments, the carrier wavelength is in the range from about 1500 nm to about 1600 nm, such as from 1540 nm to 1580 nm. Preferably, the optical source provides an optical carrier signal having a long coherence length, such that the phase of the signal is well-defined for a long period of time. The optical intensity modulation apparatus comprises an optical modulator, a radio frequency, RF, signal generator, a first optical waveguide grating and optical routing apparatus. The optical modulator is operative to modulate a continuous-wave, cw, optical carrier signal at a carrier wavelength to generate at least one sideband on the optical carrier signal. The RF signal generator is operative to provide an RF drive signal to the optical modulator. The first optical waveguide grating has a central reflection wavelength corresponding to a said sideband. The optical routing apparatus is configured to direct the optical carrier signal and the at least one sideband to the first optical waveguide grating and to direct a reflected optical signal from the first optical waveguide grating towards an output to form an output optical signal. The RF signal generator is operative to switch the drive signal on and off so as to form an intensity modulated output optical signal. The components may be arranged as described in the following: The output of the optical source may be used as input to the optical modulator. The RF signal generator may provide an RF drive signal to the optical modulator. The modulated signal output from the modulator may be input to the optical routing apparatus, which may direct the signal to the first optical waveguide grating configured to reflect a central reflection wavelength. The reflected wavelength from the grating may be input to an optical amplifier via the optical routing apparatus. An exemplary embodiment is shown in FIG. 9.

In an embodiment, the RF signal generator is operative to provide an RF drive signal comprising RF signal pulses having a compensating pulse shape such that the at least one sideband comprises optical pulses having the compensating pulse shape. The compensating pulse shape is configured to compensate for an optical amplifier non-uniform gain response in the time domain. The laser may thus be used to deliver a pre-shaped optical pulse to an optical amplifier, enabling a pulse of a desired pulse shape to be output from the optical amplifier. In some embodiments, the compensating or pre-shaped optical pulse has an exponential envelope in the amplitude or intensity, such that the desired pulse shape output from the optical amplifier is substantially rectangular in the time domain. This may be achieved by utilizing an amplitude modulated RF drive signal with an exponential envelope. An example of a pre-shaped optical pulse is shown in FIG. 17. An example of a desired pulse shape output from the optical amplifier is shown in FIG. 18.

In an alternative embodiment, the optical intensity modulation apparatus further comprises an optical amplifier and an optical detector. The optical amplifier is configured to amplify the intensity modulated output optical signal from the optical intensity modulation apparatus. The optical amplifier has a non-uniform gain response in the time domain. The optical detector is configured to detect a pulse shape of the intensity modulated output optical signal after amplification by the optical amplifier and to generate an output signal indicative of the detected pulse shape. The RF signal generator comprises interface circuitry, at least one processor and memory comprising instructions executable by said processor whereby the RF signal generator is operative as follows. To receive an output signal indicative of a detected pulse shape from the optical detector. To determine a difference between the detected pulse shape and a target pulse shape. To determine a compensating pulse shape configured to at least partly compensate for said difference. To generate the RF drive signal comprising RF signal pulses having the compensating pulse shape, such that the at least one sideband comprises optical pulses having the compensating pulse shape. The optical modulation apparatus may thus be used to deliver a pre-shaped optical pulse to the optical amplifier, enabling a pulse of a desired pulse shape to be output from the optical amplifier. Thus, an output port, such as a third port, of the optical routing apparatus may be connected to an input port of the optical amplifier via an optical fibre.

Corresponding embodiments also apply to the quantum computing system and the system for coherent excitation described below.

An aspect provides a quantum computing system comprising an optical source, optical intensity modulation apparatus and a confinement chamber. The optical source may be configured for generating a continuous-wave, cw, optical carrier signal at a carrier wavelength. The optical intensity modulation apparatus comprises an optical modulator, a radio frequency, RF, signal generator, a first optical waveguide grating and optical routing apparatus. The optical modulator is operative to modulate a continuous-wave, cw, optical carrier signal at a carrier wavelength to generate at least one sideband on the optical carrier signal. The RF signal generator is operative to provide an RF drive signal to the optical modulator. The first optical waveguide grating has a central reflection wavelength corresponding to a said sideband. The optical routing apparatus is configured to direct the optical carrier signal and the at least one sideband to the first optical waveguide grating and to direct a reflected optical signal from the first optical waveguide grating towards an output to form an output optical signal to be delivered to the confinement chamber. The RF signal generator is operative to switch the drive signal on and off so as to form an intensity modulated output optical signal.

An aspect provides system for coherent excitation comprising an optical source, optical intensity modulation apparatus and an excitation chamber. The optical source may be configured for generating a continuous-wave, cw, optical carrier signal at a carrier wavelength. The optical intensity modulation apparatus comprises an optical modulator, a radio frequency, RF, signal generator, a first optical waveguide grating and optical routing apparatus. The optical modulator is operative to modulate a continuous-wave, cw, optical carrier signal at a carrier wavelength to generate at least one sideband on the optical carrier signal. The RF signal generator is operative to provide an RF drive signal to the optical modulator. The first optical waveguide grating has a central reflection wavelength corresponding to a said sideband. The optical routing apparatus is configured to direct the optical carrier signal and the at least one sideband to the first optical waveguide grating and to direct a reflected optical signal from the first optical waveguide grating towards an output to form an output optical signal to be delivered to the excitation chamber. The RF signal generator is operative to switch the drive signal on and off so as to form an intensity modulated output optical signal.

An aspect provides a system for coherent state control of a quantum system. The apparatus comprises an optical source, optical intensity modulation apparatus and an interaction chamber for a quantum system. The optical source may be configured for generating a continuous-wave, cw, optical carrier signal at a carrier wavelength. The optical intensity modulation apparatus comprises an optical modulator, a radio frequency, RF, signal generator, a first optical waveguide grating and optical routing apparatus. The optical modulator is operative to modulate a continuous-wave, cw, optical carrier signal at a carrier wavelength to generate at least one sideband on the optical carrier signal. The RF signal generator is operative to provide an RF drive signal to the optical modulator. The first optical waveguide grating has a central reflection wavelength corresponding to a said sideband. The optical routing apparatus is configured to direct the optical carrier signal and the at least one sideband to the first optical waveguide grating and to direct a reflected optical signal from the first optical waveguide grating towards an output to form an output optical signal to be delivered to the interaction chamber. The RF signal generator is operative to switch the drive signal on and off so as to form an intensity modulated output optical signal.

The presently disclosed optical intensity modulation apparatus and associated laser system may be used in many applications, in particular it is suitable for applications that require a precise control of the phase, energy, and/or shape of the output optical signal. For instance, many quantum applications require a particular train of optical pulses having a well-defined shape, phase, and energy. Examples of such applications include atomic, molecular, and optical physics (AMO), quantum computers, cryptography, quantum gyroscopes, gravitational detection systems, and atomic clocks. The presently disclosed apparatus and system enables the state control of quantum mechanical ensembles. Other applications include distributed acoustical sensing.

### BRIEF DESCRIPTION OF THE DRAWINGS

FIGS. 1 to 7 and 14 are block diagrams illustrating embodiments of optical intensity modulation apparatus;

FIGS. 8 to 10 are block diagrams illustrating embodiments of laser systems;

FIG. 11 is a block diagram illustrating an embodiment of a system for coherent excitation of atoms or ions;

FIG. 12 is a block diagram illustrating an embodiment of a quantum computing system; and

FIG. 13 is a block diagram illustrating an embodiment of a system for coherent state control of a quantum system.

FIG. 15 to 16 are graphs showing experimental data (fall time, rise time, respectively) related to the optical intensity modulation apparatus according to the present disclosure.

FIG. 17 shows the shape of an optical pulse having a compensating pulse shape configured to for a non-uniform gain response in the time domain of an optical amplifier.

FIG. 18 shows the shape of an optical pulse output from an optical amplifier, wherein said amplifier has a non-uniform gain response in the time domain.

FIG. 19 shows the reflection spectrum of a first optical waveguide grating according to the present disclosure.

### DETAILED DESCRIPTION

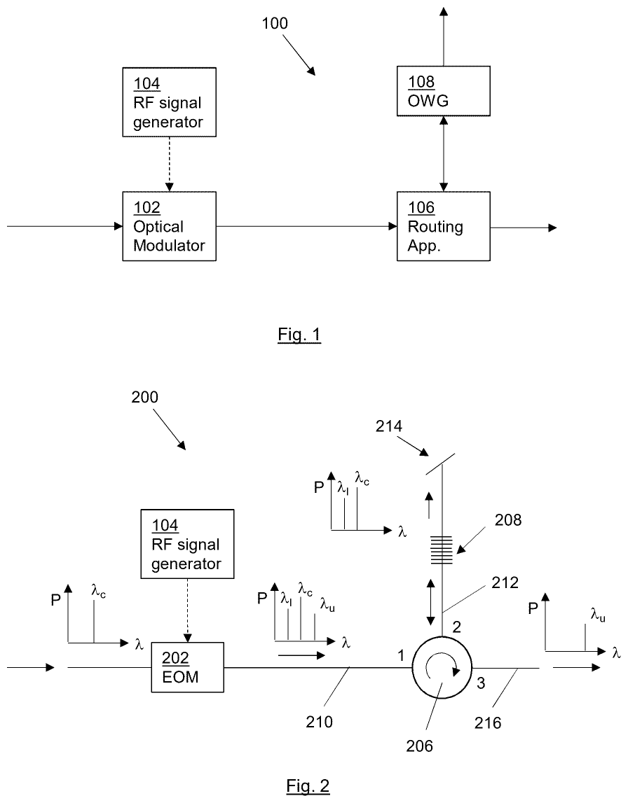

Referring to FIG. 1, an embodiment provides optical intensity modulation apparatus 100 comprising an optical modulator 102, a radio frequency, RF, signal generator 104, a first optical waveguide grating 108 and optical routing apparatus 106.

The RF signal generator is operative to provide an RF drive signal to the optical modulator.

The optical modulator is arranged in a first optical path to receive a continuous-wave, cw, optical carrier signal at a carrier wavelength. The optical modulator is operative to modulate the optical carrier signal to generate at least one sideband on the optical carrier signal. The at least one sideband may have a frequency offset from the carrier signal corresponding to the frequency of the RF drive signal.

The first optical waveguide grating, OWG, 108 is arranged in a second optical path connecting first optical waveguide grating to the optical routing apparatus and has a central reflection wavelength corresponding to a said sideband.

The optical routing apparatus 106 is configured to direct the optical carrier signal and the at least one sideband along the second optical path to the first optical waveguide grating. The optical routing apparatus 106 is configured also to direct a reflected optical signal from the first optical waveguide grating back along the second optical path towards a third optical path to an output to form an output optical signal. The optical waveguide with the first optical waveguide grating is free of a waveguide grating with a central reflection wavelength corresponding to said carrier wavelength, such that the carrier signal is not reflected towards the output and does not for part of the output optical signal. Also, the optical waveguide is free of a grating with a central reflection wavelength corresponding to any other generated sideband.

The RF signal generator is operative to switch the drive signal on and off; when the drive signal is on, the at least one sideband is generated, and when the drive signal is off, no sideband is generated. By switching the drive signal on and off an intensity modulated output optical signal is formed.

In an embodiment, the RF signal has a frequency of up to 100 GHz, such as a frequency in the range 1 GHz to 20 GHz.

In an embodiment, the RF signal generator 104 is a high-speed arbitrary waveform generator, AWG.

In an embodiment, illustrated in FIG. 2, the optical modulator is an electro-optic modulator, EOM, 202, the first optical waveguide grating is a first fibre Bragg grating, FBG, 208 and the optical routing apparatus is an optical circulator 206. Advantageously, the EOM may be configured to apply or impose a phase modulation on the carrier signal. An advantage of utilizing phase modulation is that the setup is more simple than e.g., a Mach-Zehnder (MZ) modulator. In particular, it is important to precisely control the bias voltage in a MZ-EOM, which makes the setup more complicated. This is in particular the case for pulsed light applications since it would then require complicated electronics. This is entirely avoided by utilizing a phase modulation-based EOM. A phase-modulation based EOM may be used in other embodiments described herein.

Alternatively, the optical modulator may be configured to apply or impose an amplitude modulation on the carrier signal. Thus, in some cases, the carrier signal may be both amplitude and phase modulated by the optical modulator.

The RF signal generator is operative to provide an RF drive signal to the EOM. The phase of the RF drive signal may have a known correlation with the phase of the optical carrier signal and/or the phase of the at least one sideband. In some embodiments, the phase of the RF signal does not affect the phase of the optical carrier signal. The phase of the optical signal in the 1^{st} order sideband may have a 1:1 correlation with the phase of the RF signal. For the 2^{nd} order sideband, the phase of the optical signal may be 1:2 of the phase of the RF signal. Thus, the phase of the optical signal can be controlled by controlling the phase of the RF drive signal. The phase change to the optical carrier signal may be independent of the choice of the frequency of the RF drive signal.

The EOM is arranged to receive a cw optical carrier signal at a carrier wavelength, c. The EOM is driven by the RF drive signal from the RF signal generator 104 to phase modulate the cw optical carrier signal. The EOM is operative to modulate the optical carrier signal to generate an upper sideband at an upper sideband wavelength, u, and a lower sideband at a lower sideband wavelength, l, on the optical carrier signal. The RF drive signal is at a frequency, f, therefore the sidebands are spaced from the carrier wavelength by an optical frequency offset, f. Advantageously, the corresponding wavelength offset between the carrier wavelength and a given first order sideband corresponds approximately to the reflection bandwidth of the first optical waveguide grating. This allows for accurately filtering out the sideband of interest while suppressing the reflection of the carrier signal from the grating. In some embodiments, the reflection bandwidth of the first optical waveguide grating is below 1 nm at a wavelength of 1560 nm. In other embodiments, the reflection bandwidth is between 10 pm and 100 pm at a wavelength of 1560 nm. This corresponds approximately to a bandwidth between 1.233 GHz and 12.33 GHz. Advantageously, the frequency of the RF drive signal is within the same range. In some embodiments, the first optical waveguide grating has a reflection bandwidth of between 1 GHz to 10 GHz at the carrier wavelength.

The EOM may comprise a nonlinear optical material such as a ferroelectric material like lithium niobate (LiNbO₃) or barium titanate (BaTiO₃), a polymer, an organic electro-optic material, or other suitable nonlinear materials. In particular, the EOM may comprise a nonlinear crystal whose refractive index is a function of the strength of the local electric field. Thus, the refractive index of the crystal as well as the phase of the optical signal exiting the EOM may be controlled by changing the electric field in the crystal, e.g. by controlling the RF drive signal generated by the RF signal generator.

An output of the EOM is connected to a first port, 1, of the optical circulator by a first optical fibre 210. The optical circulator is configured to route optical signals from the first port to a second port, 2, to which a second optical fibre 212 containing the first FBG 208 is connected. The optical carrier signal, upper sideband and lower sideband output from the EOM are thus directed by the optical circulator to the first FBG.

The first FBG 208 has a reflection profile including a central reflection wavelength which, in this example, corresponds to the upper sideband. A defined percentage of the upper sideband is reflected by the first FBG, depending on the reflectivity of the first FBG; this is typically in the range 90% to 99%. The optical carrier signal and the lower sideband are transmitted by the first FBG towards an optical dump 214 at an end of the optical fibre. The optical dump 214 may comprise an optical isolator. The optical isolator may be configured to allow light to propagate through it in one direction, but not in the opposite direction. The operation of the optical isolator may be based on the Faraday effect. Depending on the reflection profile of the first FBG, a small percentage (for example 0.01% to 1%) of the optical carrier signal and the lower sideband may be reflected by the FBG.

The optical circulator 206 is configured to route an optical signal reflected from the first FBG from the second port, 2, to a third port, 3, into an output optical fibre 216 to form an output optical signal. The output optical signal from the optical circulator 206 may be provided as the input to an optical amplifier (not shown in this embodiment) via the output optical fibre 216.

It will be appreciated that where an optical circulator is described as being used a four-port optical coupler may alternatively be used, preferably a 50:50 optical coupler.

The RF signal generator is operative to switch the drive signal on and off; when the drive signal is on, the upper and lower sidebands are generated, and when the drive signal is off, no sidebands are generated. In this example, when the drive signal is on, the upper sideband is present and is reflected by the first FBG and directed towards the output, as an output optical signal. By switching the drive signal on and off an intensity modulated output optical signal at the upper sideband wavelength is formed.

In an embodiment, the first FBG 208 is an apodized FBG with a raised Gaussian reflection profile and constant grating period. The first FBG 208 may be mounted on an aluminium substrate with temperature sensor and piezo actuators to control and stabilize its central reflection wavelength. Alternatively, the first FBG 208 may be mounted on a ceramic substrate. In that case, the temperature can be stabilized without the use of piezo actuators.

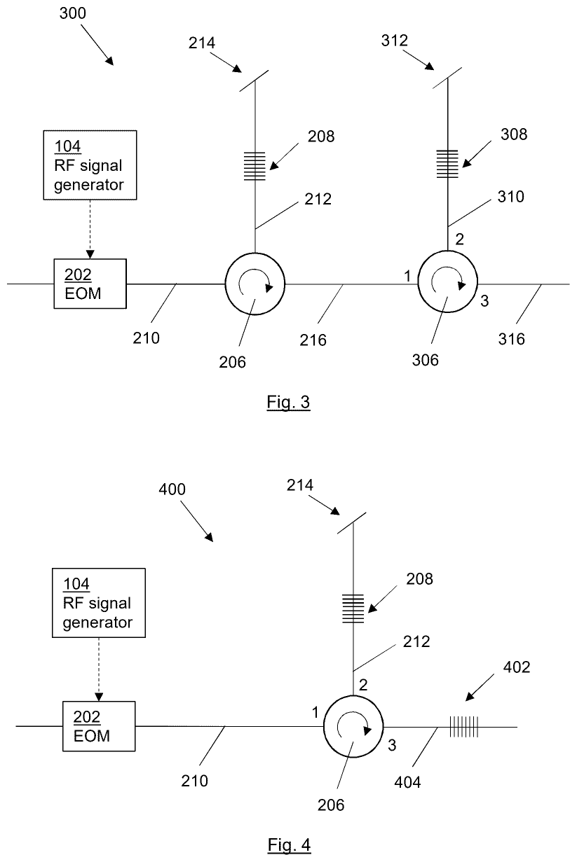

In an embodiment, illustrated in FIG. 3, the optical intensity modulation apparatus 300 additionally comprises a second optical waveguide grating and second optical routing apparatus.

The second optical waveguide grating in this example is a second FBG 308. The second optical routing apparatus in this example is a second optical circulator 306.

The third port, 3, of the optical circulator 206 is connected to a first port, 1, of the second optical circulator by the output optical fibre 216 of the optical circulator 206. The second optical circulator is configured to route optical signals from the first port to a second port, 2, to which a third optical fibre 310 containing the second FBG 308 is connected. The optical signal reflected from the first FBG 208, comprising the reflected portion of the upper sideband and, potentially, the small percentage of the optical carrier signal and the lower sideband are thus directed by the second optical circulator to the second FBG.

The second FBG 308 has a central reflection wavelength which, in this example, corresponds to the upper sideband. The second FBG 308 may have substantially the same reflection profile as the first FBG 208.

A defined percentage of the upper sideband is reflected by the second FBG, depending on the reflectivity of the second FBG; this is typically in the range 90% to 99%. The optical carrier signal and the lower sideband in the optical signal reflected from the first FBG 208 are transmitted by the second FBG towards a second optical dump 312 at an end of the third optical fibre 310. Depending on the reflection profile of the second FBG, a small percentage (for example 0.01% to 1%) of the optical carrier signal and the lower sideband may be reflected by the second FBG.

The second optical circulator 306 is configured to route an optical signal reflected from the second FBG 308 from the second port, 2, to a third port, 3, into an output optical fibre 316 to form an output optical signal. The output optical signal from the optical circulator 306 may be provided as the input to an optical amplifier (not shown in this embodiment) via the output optical fibre 316.

In an embodiment, the first FBG 208 and the second FBG 308 are apodized FBGs with a raised Gaussian reflection profile and constant grating period. The first FBG 208 and the second FBG 308 may be mounted on aluminium substrates with temperature sensor and piezo actuators to control and stabilize their central reflection wavelengths.

In an embodiment, illustrated in FIG. 4, the optical intensity modulation apparatus 400 additionally comprises an output optical waveguide grating, which in this example is a further FBG 402. The output from said grating 402 may be provided as the input to an optical amplifier (not shown in this embodiment) via an optical fibre.

As described above, the first FBG 208 has a reflection profile including a central reflection wavelength which, in this example, corresponds to the upper sideband. A defined percentage of the upper sideband is reflected by the FBG 208, depending on the reflectivity of the first FBG 208. Depending on the reflection profile of the first FBG, a small percentage (for example 0.01% to 1 %) of the optical carrier signal and the lower sideband are reflected by the first FBG 208.

The output FBG 402 may have a reflection bandwidth including the carrier wavelength and the lower sideband wavelength.

The output FBG 402 is provided in a third optical fibre 404 connected to the third port 3 of the optical circulator 206. The output FBG therefore receives the optical signal reflected by the FBG 208. The output FBG 402 transmits the upper sideband received from the first FBG 208 to form the output optical signal and reflects a defined percentage of the optical carrier signal and the lower sideband, depending on the reflectivity of the output FBG; this is typically in the range 90% to 99 %.

In an embodiment, the optical modulation apparatus 300, illustrated in FIG. 3, additionally comprises an output optical waveguide grating, for example a further FBG 402 as described above, after the second optical circulator 306. The output from the optical circulator 306 may be provided as the input to an optical amplifier (not shown in this embodiment) via the output optical fibre 316.

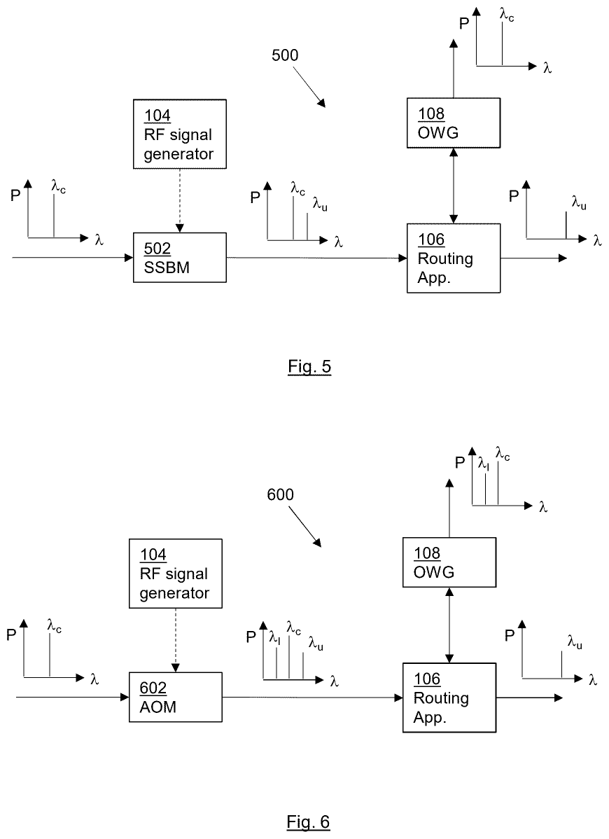

An embodiment provides optical modulation apparatus 500, illustrated in FIG. 5. In this embodiment the optical modulator is a single sideband modulator, SSBM, 502. The SSBM is operative to modulate the cw optical carrier signal to generate a single sideband, for example the upper sideband, on the optical carrier signal.

The first optical waveguide grating, OWG, 108 has a central reflection wavelength corresponding to the generated sideband, in this example the upper sideband.

An embodiment provides optical modulation apparatus 600, illustrated in FIG. 6. In this embodiment the optical modulator is an acousto-optic modulator, AOM, 602.

The AOM 602 is arranged to receive a cw optical carrier signal at a carrier wavelength, c. The AOM is driven by the RF drive signal from the RF signal generator 104. The AOM is operative to modulate the optical carrier signal to generate an upper sideband at an upper sideband wavelength, u, and a lower sideband at a lower sideband wavelength, l, on the optical carrier signal. The RF drive signal is at a frequency, f, therefore the sidebands are spaced from the carrier wavelength by an optical frequency offset, f.

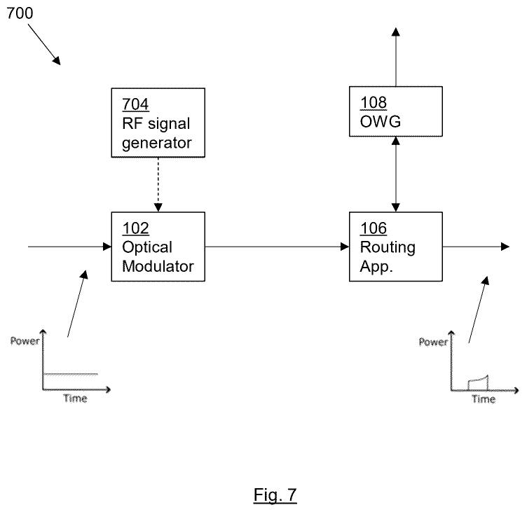

An embodiment provides optical modulation apparatus 700, illustrated in FIG. 7. In this embodiment the RF signal generator 704 is operative to provide an RF drive signal comprising RF signal pulses having a compensating pulse shape. The RF drive signal thus causes the at least one sideband generated by the optical modulator 104 to comprise optical pulses having the compensating pulse shape. The compensating pulse shape is configured to compensate for an optical amplifier non-uniform gain response in the time domain.

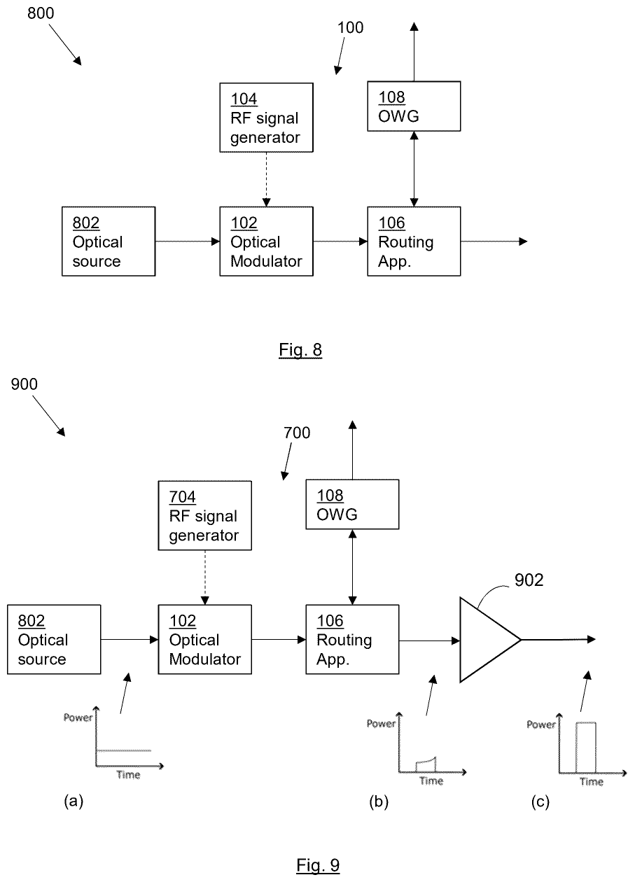

Referring to FIG. 8, an embodiment provides a laser system 800 comprising an optical source 802 and optical intensity modulation apparatus 100, as described above.

The optical source may be configured for generating a continuous-wave, cw, optical carrier signal at a carrier wavelength. The optical source may be a laser, such as a single-frequency fiber laser. The laser may have a low phase noise and a narrow linewidth. It may further have a stable single-frequency operation. The laser may comprise a gain medium, wherein a rare-earth doped fiber is used as the gain medium. As an example, the gain medium may comprise a fiber doped with Erbium (Er), Ytterbium (Yb), or Thulium (Tm). The examples given for the optical source apply to other embodiments disclosed herein. Other optical sources and lasers can be envisioned without departing from the scope of the disclosure. In some embodiments, the laser system comprises only one modulator, e.g. an electro-optic modulator (EOM).

Referring to FIG. 9, an embodiment provides a laser system 900 comprising an optical source 802, optical intensity modulation apparatus 700, as described above, and an optical amplifier 902.

The optical source may be configured for generating a continuous-wave, cw, optical carrier signal at a carrier wavelength, as illustrated in inset graph (a).

The optical amplifier is configured to amplify the intensity modulated output optical signal from the optical intensity modulation apparatus 700. The optical amplifier has a non-uniform gain response in the time domain.

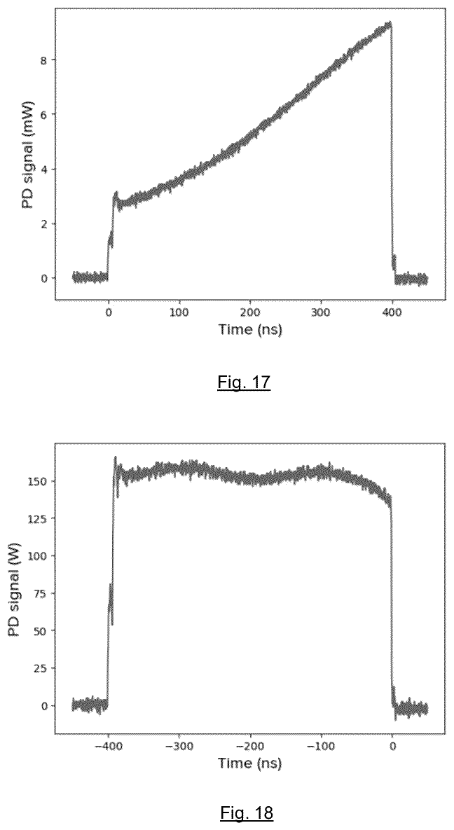

The RF signal generator 704 is operative to provide an RF drive signal comprising RF signal pulses having a compensating pulse shape. The RF drive signal thus causes the at least one sideband generated by the optical modulator 704 to comprise optical pulses having the compensating pulse shape, as illustrated in inset graph (b). The compensating pulse shape is configured to compensate for the non-uniform gain response in the time domain of the optical amplifier 902. The optical signal output from the optical amplifier thus comprises optical pulses having a desired pulse shape, as illustrated in inset graph (c). A compensating optical pulse and corresponding optical pulse having a desired pulse shape is shown in FIGS. 17-18.

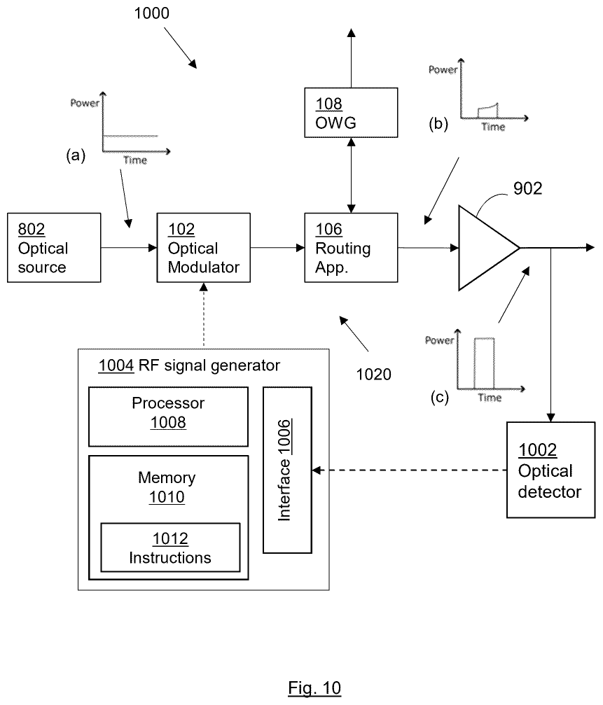

Referring to FIG. 10, an embodiment provides a laser system 1000 comprising an optical source 802, optical intensity modulation apparatus 1020, an optical amplifier 902 and an optical detector 1002.

The optical source may be configured for generating a continuous-wave, cw, optical carrier signal at a carrier wavelength, as illustrated in inset graph (a).

Similarly to the apparatus 100 described above, the optical intensity modulation apparatus 1020 comprises an optical modulator 102, optical routing apparatus 106, an optical waveguide grating, OWG, 108. The optical intensity modulation apparatus 1020 also comprises an RF signal generator 1004, having a structure and operation as described below.

The optical amplifier 902 is configured to amplify the intensity modulated output optical signal from the optical intensity modulation apparatus 1020. The optical amplifier has a non-uniform gain response in the time domain.

The optical detector 1002 is configured to detect a pulse shape of the intensity modulated output optical signal after amplification by the optical amplifier. The optical detector is additionally configured to generate an output signal indicative of the detected pulse shape.

The RF signal generator 1004 is operative to provide an RF drive signal comprising RF signal pulses having a compensating pulse shape.

The RF signal generator comprises interface circuitry 1006, a processor 1008 and memory 1010. The memory comprises instructions 1012 executable by the processor whereby the RF signal generator is operative as follows.

The RF signal generator is operative to receive an output signal from the optical detector; the output signal is indicative of a pulse shape detected by the optical detector.

The RF signal generator is operative to determine a difference between the detected pulse shape and a target pulse shape, and to determine a compensating pulse shape configured to at least partly compensate for that difference.

The RF signal generator is operative to generate the RF drive signal comprising RF signal pulses. The RF signal pulses have the compensating pulse shape. The RF drive signal thus causes the at least one sideband generated by the optical modulator 102 to comprise optical pulses having the compensating pulse shape, as illustrated in inset graph (b). The compensating pulse shape is configured to compensate for the non-uniform gain response in the time domain of the optical amplifier 902. The optical signal output from the optical amplifier thus comprises optical pulses having a desired pulse shape, as illustrated in inset graph (c).

Referring to FIG. 11, an embodiment provides a quantum computing system 1100, comprising optical source 802, optical intensity modulation apparatus 100, and a confinement chamber 1102.

The optical source may be configured for generating a continuous-wave, cw, optical carrier signal at a carrier wavelength.

The optical intensity modulation apparatus 100 is as described above. It will be understood that optical intensity modulation apparatus 700 may alternatively be used.

The confinement chamber may be an ion trap for confining ions. The output optical signal from the optical intensity modulation apparatus 100 is delivered to the ion trap to interact with trapped ions, for example for storing qubits in stable electronic states of the ions or inducing coupling between qubit states.

The confinement chamber may alternatively be an atom trap for confining atoms. The output optical signal from the optical intensity modulation apparatus 100 is delivered to the atom trap to interact with trapped atoms.

It will be understood that optical intensity modulation apparatus 700 may alternatively be used.

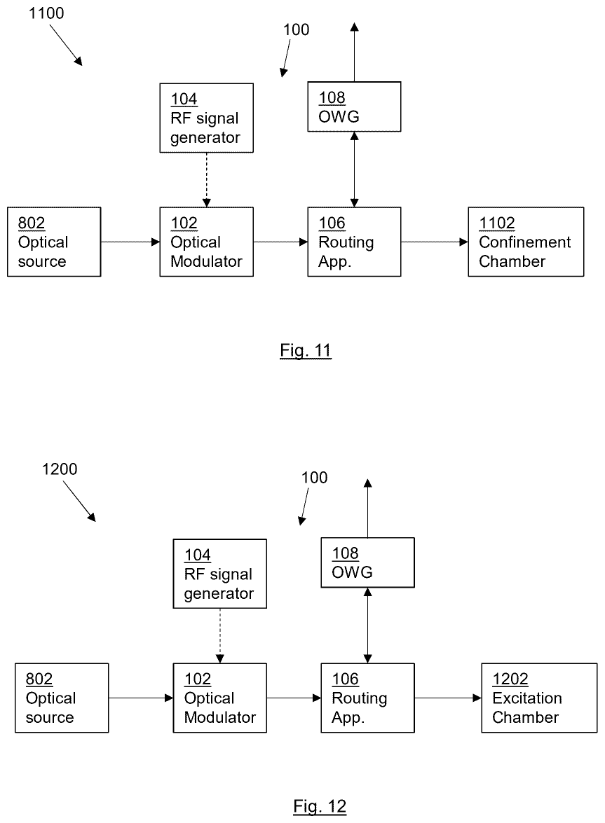

Optical intensity modulation apparatus 1020 as described above may also be used. Referring to FIG. 12, an embodiment provides a system 1200 for coherent excitation, comprising an optical source 802, optical intensity modulation apparatus 100, and an excitation chamber 1202.

The optical source may be configured for generating a continuous-wave, cw, optical carrier signal at a carrier wavelength.

The optical intensity modulation apparatus 100 is as described above. It will be understood that optical intensity modulation apparatus 700 may alternatively be used.

The output optical signal from the optical intensity modulation apparatus 100 is delivered to the excitation chamber to interact with a sample in the excitation chamber. For example, the sample may comprise atoms, such as Caesium, Strontium or Ytterbium atoms, to undergo Rydberg excitation. In an alternative example, the excitation chamber is for performing Ramsey spectroscopy on the sample.

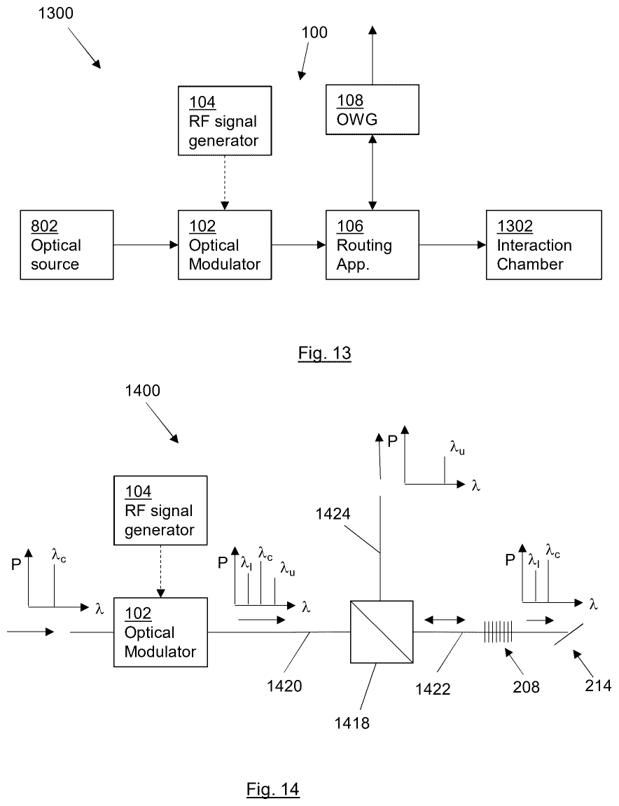

Referring to FIG. 13, an embodiment provides a system 1300 for coherent state control of a quantum system. The apparatus 1300 comprises an optical source 802, optical intensity modulation apparatus 100, and an interaction chamber 1302 for a quantum system.

The optical source may be configured for generating a continuous-wave, cw, optical carrier signal at a carrier wavelength.

The optical intensity modulation apparatus 100 is as described above. It will be understood that optical intensity modulation apparatus 700 may alternatively be used.

The output optical signal from the optical intensity modulation apparatus 100 is delivered to the interaction chamber to interact with one or more particles, for example an atom or atoms, an ion or ions, to control the quantum state of the one or more particles.

In some embodiments, the quantum system is selected from the group of: an atomic clock, an atomic interferometer, a quantum computer, a quantum gyroscope, or a quantum gravimeter. In general, the optical intensity modulation apparatus may find applications within atomic, molecular, and optical physics (AMO). In particular, the disclosed apparatus is suitable for applications that require well-defined optical pulses e.g. for controlling optical gates or quantum gates. Such applications typically require full control of the phase, shape, and energy of the optical pulses delivered. However, other applications can be envisioned without departing from the scope.

Referring to FIG. 14, an embodiment provides optical intensity modulation apparatus 1400 comprising an optical modulator 102, a radio frequency, RF, signal generator 104, a first optical waveguide grating 208. In this embodiment, the optical routing apparatus is a beam splitter 1418. The RF signal generator is operative to provide an RF drive signal to the optical modulator.

The optical modulator 102 is arranged to receive a cw optical carrier signal at a carrier wavelength, c. The optical modulator is driven by the RF drive signal from the RF signal generator 104 to phase modulate the cw optical carrier signal. The optical modulator is operative to modulate the optical carrier signal to generate an upper sideband at an upper sideband wavelength, u, and a lower sideband at a lower sideband wavelength, l, on the optical carrier signal. The RF drive signal is at a frequency, f, therefore the sidebands are spaced from the carrier wavelength by an optical frequency offset, f.

An output of the optical modulator follows a first optical path 1420 of the optical intensity modulation apparatus to the optical beam splitter 1418. The optical beam splitter is arranged to route optical signals from the first optical path to a second optical path 1422 in which the first optical waveguide grating 208 is arranged. The optical carrier signal, upper sideband and lower sideband output from the optical modulator are thus directed by the optical beam splitter to the first optical waveguide grating.

The first optical waveguide grating 208 has a reflection profile including a central reflection wavelength which, in this example, corresponds to the upper sideband. A defined percentage of the upper sideband is reflected by the first optical waveguide grating, depending on the reflectivity of the first optical waveguide grating; this is typically in the range 90% to 99%. The optical carrier signal and the lower sideband are transmitted by the first optical waveguide grating towards an optical dump 214 at an end of the second optical path. As an example, the optical dump 214 may be implemented as an optical isolator. Alternatively the optical dump 214 may be implemented as a fiber pigtail or an angle cleave of the fiber with applied graphite tape to absorb the light. Depending on the reflection profile of the first optical waveguide grating, a small percentage (for example 0.01% to 1%) of the optical carrier signal and the lower sideband may be reflected by the optical waveguide grating.

The optical beam splitter 206 is configured to route an optical signal reflected from the first optical waveguide grating along the second optical path, to a third optical path 1424 to form an output optical signal.

It will be appreciated that the optical paths at least partly may be defined by optical waveguides, such as optical fibres. The optical paths may at least partly may be defined by free-space optics.

The RF signal generator is operative to switch the drive signal on and off; when the drive signal is on, the upper and lower sidebands are generated, and when the drive signal is off, no sidebands are generated. In this example, when the drive signal is on, the upper sideband is present and is reflected by the first optical waveguide grating and directed towards the output, as an output optical signal. By switching the drive signal on and off an intensity modulated output optical signal at the upper sideband wavelength is formed. The output optical signal may comprise at least two optical pulses having a phase difference, such as π/2 or π, induced by the electro-optic modulator.

In an embodiment, the first optical waveguide grating 208 is an apodized optical waveguide grating with a raised Gaussian reflection profile and constant grating period. The first optical waveguide grating 208 may be mounted on an aluminium substrate with temperature sensor and piezo actuators to control and stabilize its central reflection wavelength.

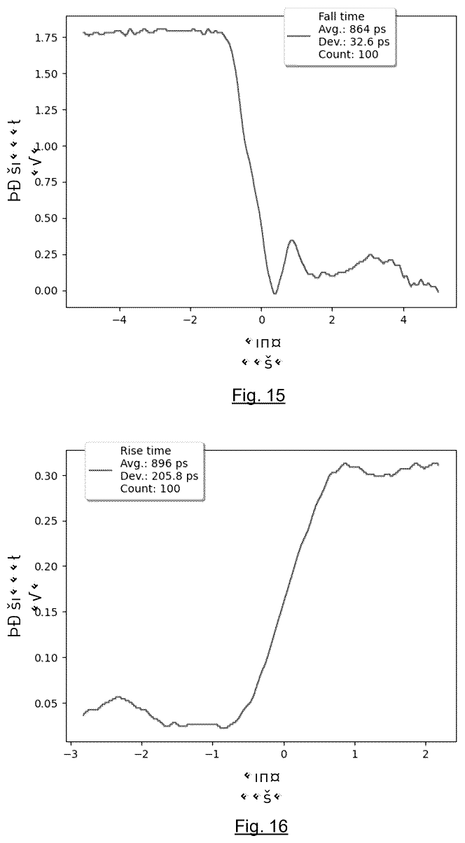

Referring to FIGS. 15-16, these show two graphs with experimental data related to the optical intensity modulation apparatus according to the present disclosure. The data is presented as two graphs showing the fall time and the rise time of the optical intensity modulation apparatus, respectively. Both graphs display the photodetector, PD, signal (V) versus the time (ns). The optical intensity modulation apparatus is seen to provide a very fast fall-and rise time of less than 1 ns, even less than 900 ps. It may even be faster than this since it is somewhat limited by the choice of detector. Here, the rise time is defined as the time between 10% PD signal to 90% PD signal, as measured by the photodetector.

Referring to FIG. 17, this graph shows the shape of an optical pulse having a compensating pulse shape configured to for a non-uniform gain response in the time domain of an optical amplifier. The graph shows the voltage of a photodetector, PD, signal (mW) versus time (ns). The pulse duration of the optical pulse is approximately 400 ns.

Referring to FIG. 18, this graph shows the shape of an optical pulse output from an optical amplifier, wherein said amplifier has a non-uniform gain response in the time domain. The amplifier received as input the optical pulse shown in FIG. 17. The optical pulse which is output by the amplifier is seen to be substantially rectangular in shape. The pulse duration is similar to the input pulse; however the peak power of the pulse is significantly amplified.

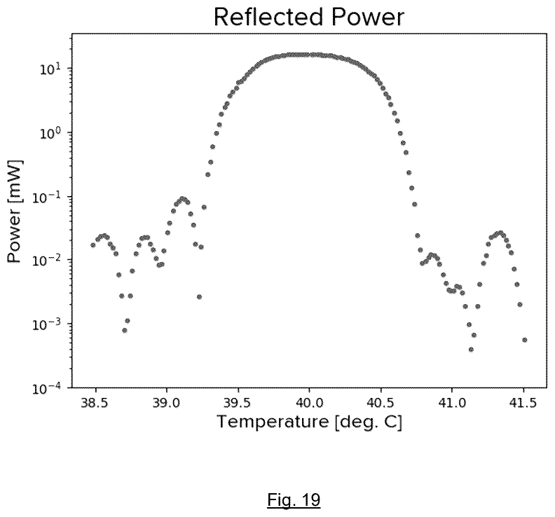

Referring to FIG. 19, this graph shows the reflection spectrum of a first optical waveguide grating according to the present disclosure. The graph shows the reflected power (mW) from the optical waveguide grating versus the temperature (° C.). This data is for a grating mounted on an aluminium substrate with a temperature sensor and piezo actuators to stabilize its central reflection wavelength. Advantageously, the frequency of the RF drive signal is selected to correspond to a minimum in the reflection spectrum. This has the technical effect that it provides an even higher extinction ratio of the optical intensity modulation apparatus. It is noted that even though the graph shows the power versus the temperature, the graph has a similar appearance if plotted as reflected power versus reflected wavelength, or reflected power versus reflected frequency. In other words, the reflected wavelength of the grating scales linearly with the temperature of the grating; thus, the shape of the graph is the same.

### List of Items

1. An optical intensity modulation apparatus (100, 200, 300, 400, 500, 600, 700) comprising:
   an optical modulator (102, 202, 502, 602) operative to modulate a continuous-wave, cw, optical carrier signal at a carrier wavelength to generate at least one sideband on the optical carrier signal;
   a radio frequency, RF, signal generator (104, 704) operative to provide an RF drive signal to the optical modulator;
   a first optical waveguide grating (108, 208) having a central reflection wavelength corresponding to a said sideband; and
   optical routing apparatus (106, 206) configured to direct the optical carrier signal and the at least one sideband to the first optical waveguide grating and to direct a reflected optical signal from the first optical waveguide grating towards an output to form an output optical signal,
   wherein the RF signal generator is operative to switch the drive signal on and off so as to form an intensity modulated output optical signal.
2. The apparatus of item 1, wherein the first optical waveguide grating is a first fibre Bragg grating (208).
3. The apparatus of item 2, wherein the first fibre Bragg grating is an apodized fibre Bragg grating having a raised Gaussian reflection profile and constant grating period.
4. The apparatus of any one of items 1 to 3, wherein the first optical waveguide grating has a reflection bandwidth equal to or less than the frequency of the RF drive signal.
5. The apparatus of any one of items 1 to 4, wherein the first optical waveguide grating has a reflection bandwidth below 1 nm.
6. The apparatus of any one of items 1 to 5, wherein the first optical waveguide grating has a reflection bandwidth from about 10 pm to about 100 pm.
7. The apparatus of any one of items 1 to 6, wherein the optical routing apparatus is an optical circulator (206).
8. The apparatus of any one of items 1 to 7, comprising an output optical waveguide grating (402) provided after the optical routing apparatus, wherein the output optical waveguide grating has a reflection bandwidth including the carrier wavelength.
9. The apparatus of any one of items 1 to 8, wherein the optical modulator and the optical routing apparatus are arranged along a first optical path and the optical routing apparatus and the first waveguide grating are arranged along a second optical path, where the second optical path does not contain an optical waveguide grating having a central reflection wavelength corresponding to the carrier signal or other generated sidebands than said sideband.
10. The apparatus of any one of items 1 to 9, further comprising:
   a second optical waveguide grating (308) having a central reflection wavelength corresponding to the said sideband; and
   second optical routing apparatus (306) configured to direct the reflected optical signal from the first optical waveguide grating to the second optical waveguide grating and to direct a second reflected optical signal from the second optical waveguide grating towards the output.
11. The apparatus of item 10, wherein the second optical waveguide grating is a second fibre Bragg grating (308).
12. The apparatus of item 11, wherein the second fibre Bragg grating is an apodized fibre Bragg grating having a raised Gaussian reflection profile and constant grating period.
13. The apparatus of any one of items 10 to 12, wherein the second optical routing apparatus is a second optical circulator (306).
14. The apparatus of any one of items 10 to 13, further comprising an output optical waveguide grating (402) provided after the second optical routing apparatus, wherein the output optical waveguide grating has a reflection bandwidth including the carrier wavelength.
15. The apparatus of item 8 or item 14, wherein the output optical waveguide grating is a further fibre Bragg grating (402).
16. The apparatus of any one of items 1 to 15, wherein:
   the optical modulator (102, 602) is operative to modulate the cw optical carrier signal to generate a lower sideband and an upper sideband on the optical carrier signal; and
   the first optical waveguide grating has a central reflection wavelength corresponding to one of the lower sideband and the upper sideband.
17. The apparatus of item 16, when dependent on any one of items 8, 14 or 15, wherein the output optical waveguide grating (402) has a reflection bandwidth including the carrier wavelength and the other of the upper sideband or the lower sideband.
18. The apparatus of any one of items 1 to 17, wherein:
   the optical modulator is a single sideband, SSB, modulator (502) operative to modulate the cw optical carrier signal to generate a single sideband on the optical carrier signal; and
   the first optical waveguide grating (108) has a central reflection wavelength corresponding to the generated sideband.
19. The apparatus of any one of items 1 to 18, wherein the RF signal has a frequency of up to 100 GHz, such as a frequency in the range 1 GHz to 20 GHz.
20. The apparatus of any one of items 1 to 19, wherein the reflection bandwidth of the first optical waveguide grating is equal to or less than the frequency of the RF signal.
21. The apparatus of any one of items 1 to 20, wherein the RF signal generator (704) is operative to provide an RF drive signal comprising RF signal pulses having a compensating pulse shape such that the at least one sideband comprises optical pulses having the compensating pulse shape, wherein the compensating pulse shape is configured to compensate for an optical amplifier non-uniform gain response in the time domain.
22. The apparatus of item 21, wherein the compensating pulse shape has an amplitude envelope with a leading edge and a trailing edge and wherein the amplitude increases between the leading edge and the trailing edge.
23. The apparatus of any one of items 21-22, wherein the amplitude of the compensating pulse increases non-linearly over at least a portion of the amplitude envelope between the leading edge and the trailing edge.
24. The apparatus of any one of items 21-23, wherein the amplitude increases substantially exponentially over at least a portion of the amplitude envelope between the leading edge and the trailing edge.
25. A laser system (800, 900, 1000) comprising:
   an optical source (802) configured for generating a continuous-wave, cw, optical carrier signal at a carrier wavelength; and
   optical intensity modulation apparatus (100, 700) according to any one of items 1 to 16.
26. A quantum computing system (1100), comprising:
   an optical source (802) configured for generating a continuous-wave, cw, optical carrier signal at a carrier wavelength;
   optical intensity modulation apparatus (100) according to any one of items 1 to 14; and
   a confinement chamber (1102).
27. A system (1200) for coherent excitation comprising:
   an optical source (802) configured for generating a continuous-wave, cw, optical carrier signal at a carrier wavelength;
   optical intensity modulation apparatus (100) according to any one of items 1 to 16; and
   an excitation chamber (1202).
28. A system (1300) for coherent state control of a quantum system, the system (1300) comprising:
   an optical source (802) configured for generating a continuous-wave, cw, optical carrier signal at a carrier wavelength;
   optical intensity modulation apparatus (100) according to any one of items 1 to 16; and
   an interaction chamber (1302) for a quantum system.
29. A system according to any one of items 25 to 28, wherein the optical intensity modulation apparatus (1020) is according to any one of items 1 to 21 and further comprises:
   an optical amplifier (902) configured to amplify the intensity modulated output optical signal from the optical intensity modulation apparatus, the optical amplifier having a non-uniform gain response in the time domain; and
   an optical detector (1002) configured to detect a pulse shape of the intensity modulated output optical signal after amplification by the optical amplifier and to generate an output signal indicative of the detected pulse shape;
   and wherein the RF signal generator (1004) comprises interface circuitry (1006), at least one processor (1008) and memory (1010) comprising instructions (1012) executable by said processor whereby the RF signal generator is operative to:
      receive an output signal indicative of a detected pulse shape from the optical detector;
      determine a difference between the detected pulse shape and a target pulse shape;
      determine a compensating pulse shape configured to at least partly compensate for said difference; and
      generate the RF drive signal comprising RF signal pulses having the compensating pulse shape, such that the at least one sideband comprises optical pulses having the compensating pulse shape.

25. An optical intensity modulation apparatus comprising:
an optical modulator configured to modulate a continuous-wave, cw, optical carrier signal at a carrier wavelength to generate at least one sideband on the optical carrier signal;
a radio frequency, RF, signal generator configured to provide an RF drive signal to the optical modulator;
a first optical waveguide grating having a central reflection wavelength substantially corresponding to one of said sideband(s); and
an optical circulator configured to direct the optical carrier signal and the at least one sideband to the first optical waveguide grating and to direct a reflected optical signal from the first optical waveguide grating towards an output to form an output optical signal, wherein a reflection of the optical carrier signal in first optical waveguide grating towards the output is less than 10% of the optical carrier signal directed to the first optical waveguide grating,
wherein the RF signal generator is configured to switch the RF drive signal on and off so as to form an intensity modulated output optical signal.

26. The apparatus as claimed in claim 25, wherein the first optical waveguide grating is a fiber Bragg grating.

27. The apparatus as claimed in claim 26, wherein the fiber Bragg grating is an apodized fiber Bragg grating having a raised Gaussian reflection profile and constant grating period.

28. The apparatus as claimed in claim 25, wherein the optical intensity modulation apparatus is configured to modulate the optical carrier signal in terms of phase and amplitude.

29. The apparatus as claimed in claim 28, wherein the optical intensity modulation apparatus is configured to control the phase and amplitude independently from each other.

30. The apparatus as claimed in claim 28, wherein the phase of the intensity modulated output optical signal corresponds to the phase of the RF drive signal.

31. The apparatus as claimed in claim 25, wherein the at least one sideband is spaced from the carrier wavelength by an optical frequency offset, wherein said frequency offset corresponds to the frequency of the RF drive signal.

32. The apparatus as claimed in claim 25, wherein the first optical waveguide grating has a reflection bandwidth equal to or less than the frequency of the RF signal.

33. The apparatus as claimed in claim 25, wherein the first optical waveguide grating has a reflection bandwidth of between 1 GHz to 10 GHz at the carrier wavelength.

34. The apparatus as claimed in claim 25, wherein the output optical signal comprises at least two optical pulses having a phase difference induced by the optical modulator.

35. The apparatus as claimed in claim 25, wherein the optical intensity modulation apparatus is configured to provide an extinction ratio higher than 30 dB.

36. The apparatus as claimed in claim 25, wherein the optical intensity modulation apparatus is configured to provide a rise time of less than 1 ns.

37. The apparatus as claimed in claim 25, wherein:
the optical modulator is configured to modulate the cw optical carrier signal to generate a lower sideband and an upper sideband on the optical carrier signal; and
the first optical waveguide grating has a central reflection wavelength corresponding to one of the lower sideband or the upper sideband.

38. The apparatus as claimed in claim 37, wherein the lower and/or upper sideband is spaced from the carrier wavelength by an optical frequency offset, wherein said frequency offset corresponds to the frequency of the RF drive signal.

39. The apparatus as claimed in claim 38, wherein the optical frequency offset corresponds approximately to the reflection bandwidth of the first optical waveguide grating.

40. The apparatus as claimed in claim 25, wherein the RF drive signal has a frequency in the range 1 GHz to 20 GHz.

41. The apparatus as claimed in claim 25, wherein the RF signal generator is configured to provide an RF drive signal comprising RF signal pulses having a compensating pulse shape such that the at least one sideband comprises optical pulses having the compensating pulse shape, wherein the compensating pulse shape is configured to compensate for a non-uniform gain response in the time domain.

42-47. (canceled)

48. The apparatus as claimed in claim 25, wherein the reflected optical signal includes the at least one sideband.
